(19) United States
(12) Patent Application Publication
(10) Pub. No.: US 2017/0099843 A1
(43) Pub. Date: Apr. 13, 2017

(54) ANIMAL REPELLENT COMPOSITION

(71) Applicant: Nancy Kerk, Gulford, CT (US)

(72) Inventor: Nancy Kerk, Gulford, CT (US)

(21) Appl. No.: 14/881,581

(22) Filed: Oct. 13, 2015

(51) Int. Cl. A01N 61/00; A01N 65/28; A01N 65/08; A01N 65/38; A01N 65/40; A01N 37/02; A01N 65/24

(52) U.S. Cl. CPC A01N 61/00; A01N 37/02; A01N 65/28; A01N 65/24; A01N 65/38; A01N 65/40; A01N 65/08

(57) ABSTRACT

Animal repellent composition in a powdered form comprising dry powdered form of whole egg, vinegar, clove, cinnamon, red pepper, garlic, mustard and broccoli mixed in effective amounts to form a synergistic composition that repels browsing animals. The composition is biodegradable, weather proof, and applied by mixing with water and spraying over the foliage to repel browsing animals including deer.

### FIELD OF THE INVENTION

The present invention generally relates to the technical field of animal repellents, and in particular the invention relates to an animal repellent composition in powder form, which can be mixed with water and applied over the foliage for repelling browsing animals such as deer, raccoons, squirrels, chipmunks, rabbits, gophers, skunks and others.

### BACKGROUND

As humans encroach on wilderness areas, there is ever more contact with natural wildlife and human activity does overlap and even attract wildlife. This can cause harm to plants and animals. Browsing animals, especially deer are considered as the most common pest by home owners and landowners in urban and exurban landscapes. Deer densities increase in these regions due to availability of rich food sources in the form of home gardens, lawns, and ornamental results in widespread destruction of homeowners' landscaping because of the proliferation of deer in the above mentioned areas. In addition to damage of plants, deer and other browser animals often carry ticks and other related parasites harboring pathogens that can cause harmful diseases to humans.

In addition to deer, squirrels can also cause considerable damage to a house when they enter and inhabit a house. Squirrels are inclined towards bird feeders and also chew on wood, dry wall, electrical wires, window siding and roof flanges, leading to extensive damage to the house. In some cases, chewing of indoor or outdoor wiring and related insulation by squirrels could result in a fire hazard.

Animal damage can be managed by methods such as habitat modification, fencing, scaring the animal using sound or light or pyrotechnic devices and using animal repellents. Many repellents exist on the market. Most only deter the animal for a very short time, while others carry an offensive smell. Furthermore, most of the repellents need to be applied on a constant basis, depending on the weather or watering schedule, and are inconvenient for the user. Animal repellent formulations require approval of the Environmental Protection Agency (“EPA”) and are generally required to be non-toxic to animals, birds and insects.

Prior art animal repellents comprising oil or gum based formulations tend to coat the entire surface of leaves, which might block stomatal openings and interfere with the plant's gaseous exchange. Another class of existing repellents include chemical compounds such as pyrethrin which is known to be toxic to a variety of insects, thereby indirectly affecting pollination. Further, the prior art animal repellents comprising liquid preparations, which are sold commercially in plastic spray bottles or similar containers, contribute to increased cost associated with shipping, storage and waste disposal.

Therefore, there exists a need for an effective, low cost, powder form animal repellent formulation that doesn't interfere with plant growth or plant functions and also non-toxic to birds, animals and insects.

### SUMMARY OF THE INVENTION

The present invention relates to an animal repellent composition in a powdered form comprising dry powdered form of whole egg, vinegar, clove, cinnamon, red pepper, garlic, mustard and broccoli mixed in effective amounts to form a synergistic composition. The composition is configured to be mixed with water and sprayed over the foliage to repel browsing animals including deer. The composition doesn't interfere with the growth or function of plants or plant parts including leaves, flowers, etc.

In an embodiment, the animal repellent composition comprises a deer repellent. The animal repellent composition can also be used to deter other animals such as raccoons, squirrels, chipmunks, rabbits, gophers and skunks among other such animals. The animal repellent composition comprises a dry powdered form, which can be mixed with water before applying onto a surface such as vegetation or inanimate objects.

In an embodiment, the present invention relates to a method comprising the steps of: i) Preparing an animal repellant composition comprising dry powdered form of whole egg, vinegar, clove, cinnamon, red pepper, garlic, mustard and broccoli mixed in effective amounts to form a synergistic composition that repels browsing animals; ii) Mixing a predefined amount of the animal repellant composition with water; and iii) applying the animal repellant composition onto a target area comprising a surface of a foliage or an inanimate object.

In an embodiment, the animal repellant composition consisting essentially of by volume: 26% whole egg powder, 13% powdered vinegar, 4.3% ground cloves, 4.3% ground cinnamon, 13% ground red pepper, 13% garlic powder, 13% mustard, and 13% broccoli powder.

### BRIEF DESCRIPTION OF DRAWINGS

FIG. 1 illustrates a flowchart of a method according to an embodiment of the present invention.

### DETAILED DESCRIPTION OF DIFFERENT EMBODIMENTS

The present invention relates to animal repellent composition comprising powdered form of readily available home based food materials such as whole egg, vinegar, clove, cinnamon, red pepper, garlic, mustard and broccoli mixed in effective amounts to form a synergistic composition. The animal repellent composition is configured to be mixed with water and sprayed over the foliage including flower gardens, ornamentals, shrubbery and vegetable gardens to repel browsing animals such as deer. The animal repellent composition works by causing avoidance to predators based on olfactory and taste factors. Application of the product is mainly by spraying or applying with other watering methods.

The main adjuvant is whole egg powder, which promotes sticking to a variety of surfaces such as foliage, tree trunks, wooden frames, metal containers, etc. The mustard powder comprises olfactory and taste deterrent qualities but is primarily used as an emulsifier to hold the finely ground components in a suspension when mixed with water. An optional ingredient is in the form of a commercially available nutrient supplement containing galantamine. It is made from an extract of a plant from the daffodil family and used as a memory enhancer in humans, but daffodils are highly avoided by deer and other browser animals, thus used as a deterrent.

In an exemplary embodiment, the animal repellent composition of the present invention comprises the following food based materials in the ranges, as set forth in the Table 1.

TABLE 1

| | | Percentage by |
|---|---|---|
| S. no | Material | Volume |
| 1 | Whole egg powder | 26 |
| 2 | Powdered vinegar | 13 |
| 3 | Ground cloves | 4.3 |
| 4 | Ground cinnamon | 4.3 |
| 5 | Ground red pepper | 13 |
| 6 | Garlic powder | 13 |
| 7 | Mustard #4 | 13 |
| 8 | Broccoli powder | 13 |

The animal repellent composition of the present invention comprises a powdered form that doesn't affect the growth or appearance of plants. The animal repellent is not visible on the plant surface after spraying or applying and doesn't coat the entire surface of leaves, as coating the whole leaf surface might block stomata and interfere with gaseous exchange and other related physiological functions of the plant. The animal repellent composition has adherent components that allow the repellent compounds to retain to a variety of surfaces, thus minimal repeated application is required. It also adheres well to surfaces even under harsh weather conditions including unpredictable snow and rain. In an embodiment, the animal repellent composition comprises a deer repellent.

In an embodiment, plants treated with the animal repellent composition of the present invention attracts a healthy population of insects as the composition doesn't contain any chemicals that are harmful to insects. The product is exempt from registration with the Federal Environmental Protection Agency under FIFRA regulations. The composition is also capable of deterring other browser animals in addition to deer, such as raccoons, squirrels, chipmunks, rabbits, gophers, skunks and others. In an embodiment, the animal repellent composition of the present invention can be applied to poles or branches where squirrels try to get towards bird feeders. The animal repellent composition also deters squirrels from reaching out to bird feeders, without affecting birds. The animal repellent composition can also be applied on different access points leading to wires, insulations, windows, roof flanges and other building structures to deter entry and inhabitation by squirrels and also prevents potential fire hazards that might result from damaged electrical wiring and insulation due to chewing by squirrels.

In an embodiment, the present invention relates to an animal repellent product that provides an ease of use for home gardeners with “easy-to-use” packaging that has minimal impact on the environment, when concerning disposal of packaging materials. The animal repellent of the present invention is biodegradable and very simple to prepare for home use. One packet weighing only 0.5 oz can make up to 2.5 gallon of repellent product when mixed with water in a can or sprayer. The powdered form and packing allows landowners, homeowners or farmers to save costs associated with shipping, storage and waste disposal, in contrast to the increased costs associated with conventional animal repellent product containers. In addition, dry powdered form of the animal repellent of the present invention confers increased stability than liquid formulations. The powdered form of animal repellent can be packed in airtight containers, wherein a sufficient amount of the powder can be taken from the container and hydrated by mixing with water before use.

Generally, existing animal repellents in pre-mixed aqueous formulations consist water or oil contributing to a significant percentage of ingredients whereas main active ingredients amount only to a lesser percentage by volume. On the other hand, the animal repellent of the present invention is in dry powdered form consisting approximately 100% of active ingredients which acts synergistically to repel browsing animals.

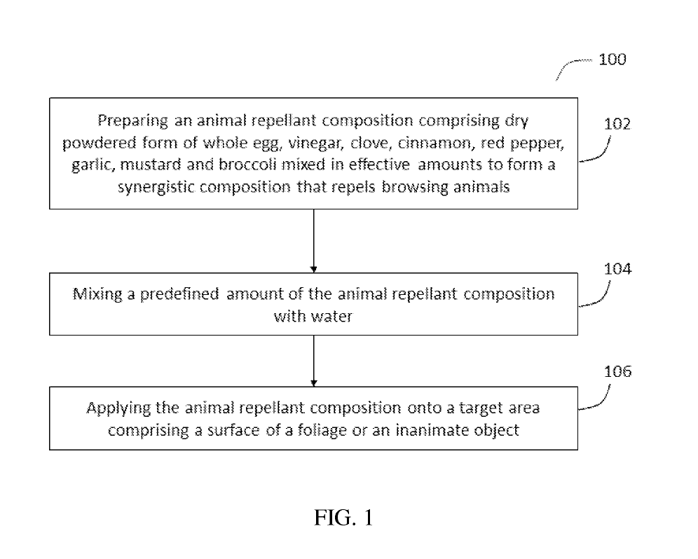

In an embodiment, the present invention relates to a method 100 as illustrated in FIG. 1, the method 100 comprising the steps of: Preparing an animal repellant composition comprising dry powdered form of whole egg, vinegar, clove, cinnamon, red pepper, garlic, mustard and broccoli mixed in effective amounts to form a synergistic composition that repels browsing animals, as shown in step 102; Mixing a predefined amount of the animal repellant composition with water, as shown in step 104; and applying the animal repellant composition onto a target area comprising a surface of a foliage or an inanimate object, as shown in step 106.

In an embodiment, the animal repellent composition of the present invention consisting essentially of by volume: 26% whole egg powder; 13% powdered vinegar; 4.3% ground cloves; 4.3% ground cinnamon; 13% ground red pepper; 13% garlic powder; 13% mustard; and 13% broccoli powder.

The powdered form of animal repellent does not form a film on the surface of the foliage. The powdered form of animal repellent can be easily prepared for application by mixing with water. The animal repellent of the present invention eliminates the need for elaborate hydration methods involving complex solvent systems or adsorbent matrices.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An animal repellent composition in a powdered form comprising:
dry powdered form of whole egg, vinegar, clove, cinnamon, red pepper, garlic, mustard and broccoli mixed in effective amounts to form a synergistic composition that repels browsing animals.

2. The animal repellent composition of claim 1 consisting essentially of by volume:
26% whole egg powder;
13% powdered vinegar;
4.3% ground cloves;
4.3% ground cinnamon;
13% ground red pepper;
13% garlic powder;
13% mustard;
and 13% broccoli powder.

3. The animal repellent composition of claim 1, further comprises galantamine.

4. The animal repellent composition of claim 1, comprises a deer repellent.

5. The animal repellent composition of claim 1, is weatherproof.

6. The animal repellent composition of claim 1, is non-toxic to birds, insects, animals and humans.

7. The animal repellent composition of claim 1, is biodegradable.

8. A method comprising:
preparing an animal repellant composition in a dry powdered form for repelling browsing animals;
mixing a predefined amount of the animal repellant composition with water; and
applying the animal repellant composition onto a target area;
wherein the animal repellant composition consisting essentially of by volume: 26% whole egg powder, 13% powdered vinegar, 4.3% ground cloves, 4.3% ground cinnamon, 13% ground red pepper, 13% garlic powder, 13% mustard, and 13% broccoli powder.

9. The method of claim 7, wherein the target area comprises a foliage surface.

10. The method of claim 7, wherein the target area comprises an inanimate object.
